(19) United States
(12) Patent Application Publication
(10) Pub. No.: US 2010/0043442 A1
(43) Pub. Date: Feb. 25, 2010

(54) DIMPLED SERRATED FINTUBE STRUCTURE

(75) Inventors: Hua Zhang, Greer, SC (US); Sal Albert Leone, Scotia, NY (US); Thomas Francis Taylor, Greenville, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/193,800

(22) Filed: Aug. 19, 2008

(51) Int. Cl. F02C 1/00; F28F 1/42; F02G 1/00

(52) U.S. Cl. 60/772; 165/179; 60/39.182

(57) ABSTRACT

Disclosed is a fin tube for thermal energy transfer of turbomachine exhaust including a tube disposable in an exhaust stream of a turbomachine and a plurality of fins extending from an outer surface of the tube. Each fin includes a plurality of adjacent fin segments which are separated by a serration. At least one fin segment of the plurality of fin segments includes at least one dimple thereon. The at least one dimple increases a turbulence of exhaust flow across the at least one fin segment and increases a surface area of the at least one fin segment thereby increasing a thermal energy transfer capability of the fin tube. Further disclosed is a combined cycle power plant utilizing the fin tube and a method for operating the combined cycle power plant.

### BACKGROUND

The subject invention relates to turbomachinery. More particularly the subject invention relates to heat transfer of exhaust in combined cycle power plants.

In a combined cycle power plant (CCPP), or combined cycle gas turbine (CCGT) plant, output from a generator, typically a gas turbine, is utilized to generate electricity. Since the gas turbine produces excess heat that is not utilized in the generator, a heat recovery steam generator (HRSG) is employed to transfer the excess heat from the gas turbine to a steam turbine where additional electricity is generated, thus enhancing overall efficiency of electrical generation by the CCPP.

To transfer the excess heat into energy usable by the steam turbine, conduits containing a fluid, for example, water, are placed in the exhaust path of the gas turbine. The conduits, or fin tubes, typically have a plurality of fins extending from the fin tubes to increase the heat transfer capability of the fin tubes. Further the fins are often serrated to increase the fin surface area and increase the heat transfer capabilities of the fin tubes. The fluid is evaporated into steam which drives the steam turbine. Fin tubes with improved heat transfer coefficients to improve the performance of the HRSG and/or reduce a cost of the HRSG would be well received in the art.

### BRIEF DESCRIPTION OF THE INVENTION

According to one aspect of the invention, a fin tube for thermal energy transfer of turbomachine exhaust includes a tube disposable in an exhaust stream of a turbomachine and a plurality of fins extending from an outer surface of the tube. Each fin includes a plurality of adjacent fin segments which are separated by a serration. At least one fin segment of the plurality of fin segments includes at least one dimple thereon. The at least one dimple increases a turbulence of exhaust flow across the at least one fin segment and increases a surface area of the at least one fin segment thereby increasing a thermal energy transfer capability of the fin tube.

According to another aspect of the invention, a combined cycle power plant includes a gas turbine, a steam turbine, and a plurality of fin tubes disposed in an exhaust stream of the gas turbine. The plurality of fin tubes are in flow communication with the steam turbine and are capable of transferring thermal energy from the exhaust stream to fluid disposed in the plurality of fin tubes, thereby producing a vapor to drive the steam turbine. Each fin tube of the plurality of fin tubes includes a tube and a plurality of fins extending from an outer surface of the tube. Each fin of the plurality of fins includes a plurality of adjacent fin segments which are separated by a serration. At least one fin segment of the plurality of fin segments includes at least one dimple thereon. The at least one dimple increases a turbulence of exhaust flow across the at least one fin segment and increasing a surface area of the at least one fin segment thereby increasing a thermal energy transfer capability of the plurality of fin tubes.

According to yet another aspect of the invention, a method for operating a combined cycle power plant includes powering a primary generator through the operation of a gas turbine and flowing an exhaust of the gas turbine across a plurality of fin tubes disposed in an exhaust path of the gas turbine. Each fin tube of the plurality of fin tubes includes a tube and a plurality of fins extending from an outer surface of the tube. Each fin of the plurality of fins includes a plurality of adjacent fin segments separated by a serration. At least one fin segment of the plurality of fin segments includes at least one dimple thereon. The at least one dimple increases a turbulence of exhaust flow across the at least one fin segment and increases a surface area of the at least one fin segment thereby increasing a thermal energy transfer capability of the plurality of fin tubes. The method further includes evaporating a volume of fluid contained in the plurality of fin tubes into a vapor, driving a steam turbine with the vapor, and powering a secondary generator through operation of the steam turbine.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic view of a combined cycle power plant;

FIG. 2 is a cross-sectional view of an embodiment of a fin tube;

FIG. 3 is a plan view of another embodiment of a fin tube;

FIG. 4 is a cross-sectional view of a fin tube of FIG. 2 or FIG. 3; and

FIG. 5 is an alternative cross-section view of a fin tube of FIG. 2 or FIG. 3.

The detailed description explains embodiments of the invention, together with advantages and features, by way of example with reference to the drawings.

### DETAILED DESCRIPTION OF THE INVENTION

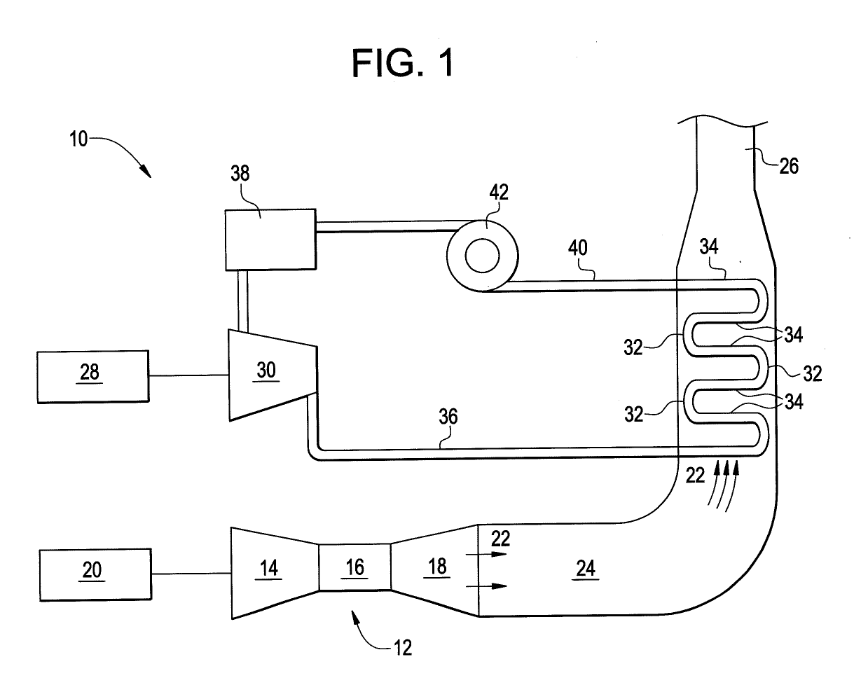

Shown in FIG. 1 is a schematic of a combined cycle power plant (CCPP) 10. The CCPP 10 includes a gas turbine 12. The gas turbine 12 includes a compressor 14 which compresses air and delivers the compressed air to at least one combustor 16 where the compressed air is mixed with a fuel and ignited. The hot gas product of the combustion process flows to a turbine 18 which extracts work from the hot gas to drive a primary generator 20 which outputs electrical power. After flowing through the turbine 18, the hot gas or exhaust 22, flows through an exhaust duct 24 toward a stack 26 for release into atmosphere.

The CCPP 10 includes a secondary generator 28 which is driven by at least one steam turbine 30. The at least one steam turbine 30 is powered by energy transferred from the exhaust 22 via a heat recovery steam generator (HRSG). The HSRG comprises a plurality of fin tubes 32 which is disposed at least partially in a path of the exhaust 22. As shown in the embodiment of FIG. 1, the plurality of fin tubes 32 is disposed in the exhaust duct 24. In other embodiments however, the plurality of fin tubes 32 may be disposed in other locations, for example, in the stack 26 or both in the exhaust duct 24 and the stack 26. In some embodiments, as shown in FIG. 1, the plurality of fin tubes 32 is disposed in a coil configuration, with multiple interconnected lengths 34 disposed in the exhaust duct 24. A volume of fluid, in some embodiments, water, is disposed in the plurality of fin tubes 32. As the exhaust 22 flows across the plurality of fin tubes 32, heat from the exhaust 22 is transferred to the fluid contained in the plurality of fin tubes 32 and evaporates the fluid into vapor. The plurality of fin tubes 32 is operably connected to the at least one steam turbine 30 via at least one turbine conduit 36. The vapor flows to the at least one steam turbine 30 via the at least one turbine conduit 36 and through the at least one steam turbine 30 to drive the secondary generator 28. In some embodiments, the vapor flows from the at least one steam turbine 30 to a condenser 38 which condenses the vapor to liquid. The liquid is urged to the plurality of fin tubes 32 via at least one input conduit 40 by at least one pump 42.

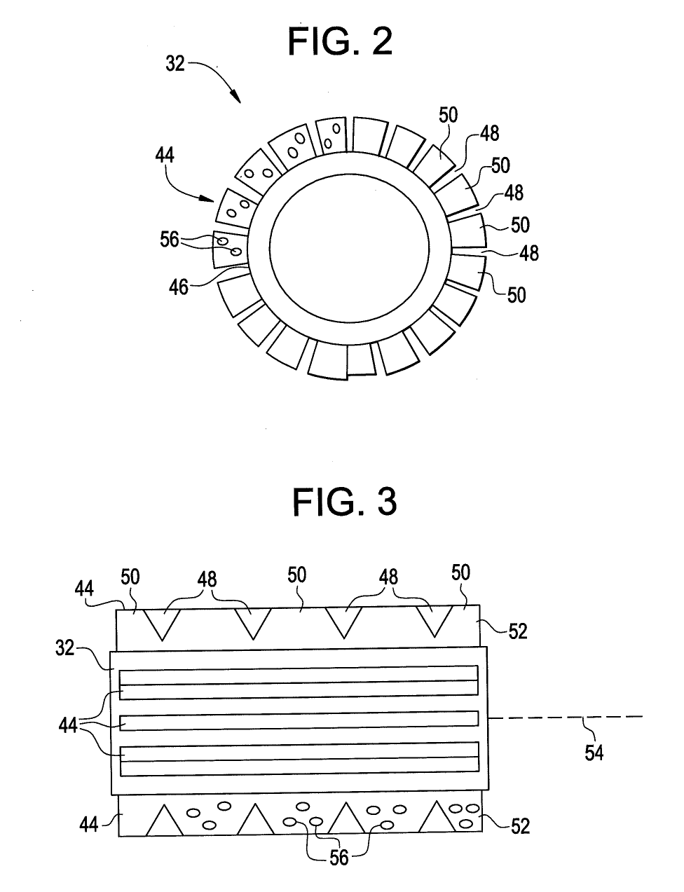

As shown in FIG. 2, each fin tube 32 of the plurality of fin tubes 32 includes a plurality of fins 44 which extend outward from an outer surface 46 of each fin tube 32 of the plurality of fin tubes 32. Each fin 44 of the plurality of fins 44 includes a plurality of serrations 48, or gaps, which divide each fin 44 into a number of fin segments 50. The plurality of serrations 48 allow for increased flow volume past the plurality of fin tubes 32 and increase an effectiveness of heat transfer from the exhaust 22 to the plurality of fin tubes 32 by increasing a heat transfer coefficient. The plurality of fins 44 are configured and disposed to increase a surface area of the fin tube 32 exposed to the exhaust 22. In the embodiment of FIG. 2, the plurality of fins 44 are arranged in a helical configuration around each fin tube 32. The plurality of fins 44 at each fin tube 32 may, however, be arranged in alternate configurations. In another embodiment, as shown in FIG. 3, the plurality of fins 44 are disposed at each fin tube 32 such that a fin surface 52 extends longitudinally along the fin tube 32 substantially parallel to a fin tube axis 54.

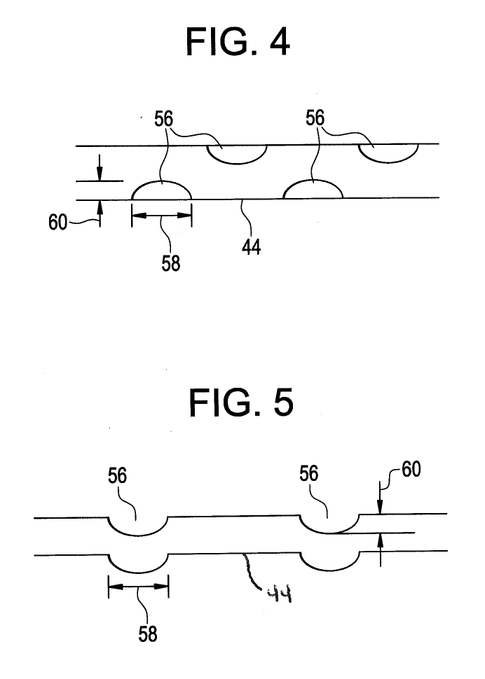

As shown in FIG. 4, the plurality of fins 44 further includes a plurality of dimples 56 disposed on at least one of the fins 44. The plurality of dimples 56 as shown in FIG. 4 are generally concave in shape. In an alternative embodiment, as shown in FIG. 5, the plurality of dimples 56 is concave on one side and convex on the opposite side. In some embodiments the plurality of dimples 56 are substantially circular and have a diameter 58 in the range of about 0.01″ to about 0.224″, and in one embodiment in the range of about 0.05″ to about 0.124″. Further, the plurality of dimples 56 have a depth 60 in the range of about 0.01″ to about 0.2″, and in one embodiment in the range of about 0.02″ to about 0.1″. It is to be appreciated that the diameters 58 and depths 60 listed herein are merely exemplary, and that other ranges of diameters 58 and depths 60 are contemplated within the scope of the present disclosure. The plurality of dimples 56 are configured and disposed in combination with the plurality of serrations 48 to increase turbulence in the flow of exhaust 22 past the plurality of fin tubes 32. The increased turbulence increases the heat transfer coefficient of the plurality of fins 44 thereby increasing the heat transfer capability of the plurality of fin tubes 32.

Further, the plurality of fin tubes 32 including a plurality of dimples 56 has a larger surface area than an undimpled fin tube. The increase in surface area provided by the addition of the plurality of dimples 56 increases a total heat transfer area of the plurality of fin tubes 32 thereby further increasing the heat transfer capability of the plurality of fin tubes 32.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fin tube for thermal energy transfer of turbomachine exhaust comprising:
a tube disposable in an exhaust stream of a turbomachine; and
a plurality of fins extending from an outer surface of the tube, each fin of the plurality of fins comprising a plurality of fin segments, adjacent fin segments of the plurality of fin segments separated by a serration, at least one fin segment of the plurality of fin segments including at least one dimple thereon, the at least one dimple increasing a turbulence of exhaust flow across the at least one fin segment and increasing a surface area of the at least one fin segment thereby increasing a thermal energy transfer capability of the fin tube.

2. The fin tube of claim 1 wherein the plurality of fins are arranged in a substantially helical pattern around a perimeter of the fin tube.

3. The fin tube of claim 1 wherein the plurality of fins extend substantially longitudinally along the fin tube.

4. The fin tube of claim 1 wherein at least one dimple of the plurality of dimples is substantially circular.

5. The fin tube of claim 4 wherein the at least one dimple of the plurality of dimples has a diameter in a range from about 0.01″ to about 0.224″

6. The fin tube of claim 5 wherein the at least one dimple of the plurality of dimples has a diameter in a range from about 0.05″ to about 0.124″.

7. The fin tube of claim 1 wherein at least one dimple of the plurality of dimples has a depth in a range from about 0.01″ to about 0.2″.

8. The fin tube of claim 7 wherein the at least one dimple of the plurality of dimples has a depth in a range from about 0.02″ to about 0.1″.

9. A combined cycle power plant comprising:
a gas turbine;
a steam turbine; and
a plurality of fin tubes disposed in an exhaust stream of the gas turbine, the plurality of fin tubes in flow communication with the steam turbine and capable of transferring thermal energy from the exhaust stream to fluid disposed in the plurality of fin tubes thereby producing vapor to drive the steam turbine, each fin tube of the plurality of fin tubes comprising:
a tube; and
a plurality of fins extending from an outer surface of the tube, each fin of the plurality of fins comprising a plurality of fin segments, adjacent fin segments of the plurality of fin segments separated by a serration, at least one fin segment of the plurality of fin segments including at least one dimple thereon, the at least one dimple increasing a turbulence of exhaust flow across the at least one fin segment and increasing a surface area of the at least one fin segment thereby increasing a thermal energy transfer capability of the plurality of fin tubes.

10. The combined cycle power plant of claim 9 wherein the plurality of fin tubes are arranged in a coil configuration.

11. The combined cycle power plant of claim 9 wherein the plurality of fins are arranged in a substantially helical pattern around a perimeter of at least one fin tube of the plurality of fin tubes.

12. The combined cycle power plant of claim 9 wherein the plurality of fins extend substantially longitudinally along at least one fin tube of the plurality of fin tubes.

13. The combined cycle power plant of claim 9 wherein at least one dimple of the plurality of dimples is substantially circular.

14. The combined cycle power plant of claim 9 wherein output from the gas turbine drives a primary generator.

15. The combined cycle power plant of claim 9 wherein output from the steam turbine drives a secondary generator.

16. A method for operating a combined cycle power plant comprising:
powering a primary generator through the operation of a gas turbine;
flowing an exhaust of the gas turbine across a plurality of fin tubes disposed in an exhaust path of the gas turbine, each fin tube of the plurality of fin tubes including:
a tube; and
a plurality of fins extending from an outer surface of the tube, each fin of the plurality of fins comprising a plurality of fin segments, adjacent fin segments of the plurality of fin segments separated by a serration, at least one fin segment of the plurality of fin segments including at least one dimple thereon, the at least one dimple increasing a turbulence of exhaust flow across the at least one fin segment and increasing a surface area of the at least one fin segment thereby increasing a thermal energy transfer capability of the plurality of fin tubes;
evaporating a volume of fluid contained in the plurality of fin tubes into a vapor;
driving a steam turbine with the vapor; and
powering a secondary generator through operation of the steam turbine.

17. The method of claim 16 comprising:
condensing the vapor into liquid;
urging the liquid to the plurality of fin tubes disposed in the exhaust stream.

18. The method of claim 17 wherein the liquid is urged to the plurality of fin tubes via at least one pump.
